(19) United States
(12) Patent Application Publication
(10) Pub. No.: US 2017/0245657 A1
(43) Pub. Date: Aug. 31, 2017

(54) MULTI-CRADLE SYSTEM FOR MANAGING MULTIPLE INFANTS

(71) Applicant: United Arab Emirates University, Al Ain (AE)

(72) Inventors: Basel Alsayyed Ahmad, Edmonton (CA); Maryam Hamad Helal Thabet Alkuwaiti, Al Ain (AE); Hadeer Rashed Salem Alsoori Alzaabi, Al Ain (AE); Wadha Ali Yaser Saif Aleryani, Al Ain (AE); Shaikhah Qasem Abdulla M. Alkindi, Al Ain (AE)

(21) Appl. No.: 15/514,352

(22) PCT Filed: Sep. 28, 2014
(86) PCT No.: PCT/IB2014/064905

§ 371 Date: Mar. 24, 2017

(51) Int. Cl. A47D 9/02; G08B 21/02; A47D 15/00

(52) U.S. Cl. CPC A47D 9/02; A47D 15/008; G08B 21/0227; G08B 21/028; G08B 21/0294; H04L 67/306

(57) ABSTRACT

A multi-cradle system for managing multiple infants is provided. The multi-cradle system includes multiple cradles to carry multiple infants. The cradles are mounted on a supporting frame. Each cradle is assigned a unique identifier. The system includes a profile module and a mapping module. The profile module is configured for storing at least one user profile of an infant. The mapping module is configured for dynamically linking the user profile to one of the cradles using the unique identifier thereof, when the infant is placed therein.

### BACKGROUND OF THE PRESENT INVENTION

Technical Field

The present invention generally relates to infant caretaking. More specifically, the present invention relates to a multi-cradle system adapted for managing multiple infants.

Description of the Related Art

Child rearing during early years of birth is a challenging and time-consuming task. Infants require virtually constant attention throughout the day in terms of feeding, medication, sanitation, and so on. A particularly time consuming and exhausting task is soothing an infant especially when the infant becomes irritable after long periods of being awake, which usually requires a parent to carry the infant and perform gentle rocking movements.

Several child carrying devices and apparatus have been developed and made available to assist parents in child rearing. However, various such assemblies available in the state of the art are directed towards domestic uses and as such, are configured to carry one or at most, two or three infants.

As the pace of life increases, single parent families and nuclear families with both parents working are becoming the norm. Accordingly, several different manifestations of child care facilities have gained significant importance in recent times. Such child care facilities usually employ a few attendants who are responsible for caretaking of several infants and toddlers. Various problems related to understaffing, insufficient and/or untimely care, and so on abound in such child care facilities.

In light of the foregoing, there is a need for such a system for caretaking of infants that not only reduces reliance on human monitoring and supervision and accordingly, reduces required manpower, but also ensures delivery of timely and proper care to the infants.

### SUMMARY OF THE PRESENT INVENTION

It is an object of the present invention to provide a system for facilitating efficient caretaking and management of multiple infants with minimum adult supervision.

The object of the present invention is achieved through a multi-cradle system according to claim 1. Further embodiments of the present invention are addressed in the dependent claims.

The underlying concept of the present invention is to implement a multi-cradle system including multiple cradles configured to provide rocking and rotational movements to multiple infants simultaneously. Each cradle has a unique identifier and each infant is associated with a user profile. When an infant is placed in a cradle, the user profile of the infant is dynamically linked to the unique identifier thereof. The user profile of an infant can be configured to include any desired information related to the infant such as medication timings, feeding timings, emergency contact details, and so on. The user profile may also include authentication information such that a parent and/or a guardian of the infant may remotely monitor the infant through streaming audio-video feeds over a data network.

In accordance with various technical features of the present invention, a multi-cradle system adapted for managing multiple infants is provided. The multi-cradle system comprises multiple cradles, a profile module, and a mapping module. The cradles are mounted on a supporting frame. Each cradle is assigned a unique identifier. The profile module is configured for storing at least one user profile of an infant. The mapping module is configured for dynamically linking the user profile to one of the cradles using the unique identifier thereof, when the infant is placed therein.

The user profile may be dynamically created for a new user. To avoid creating a new user profile every time an infant is to be managed using the multi-cradle system, the user profile may be created once and then, stored in any suitable external memory device. When next time the same infant is to be managed, the parent or the guardian may simply provide the external memory device wherefrom the relevant user profile is retrieved enabling quicker set-up.

As will be evident, the present invention facilitates management of multiple infants. Owing to systematic handling of infant needs through respective user profiles, the present invention reduces reliance on adult supervision and helps in attending to various child care tasks in a convenient and timely manner.

### BRIEF DESCRIPTION OF THE DRAWINGS

The present invention is further described hereinafter with reference to illustrated embodiments shown in the accompanying drawings, in which:

FIGS. 1A-1B illustrate a schematic view of a multi-cradle system and an individual cradle thereof respectively in accordance with various exemplary embodiments of the present invention,

FIG. 2 illustrates a block diagram of a cradle management system in accordance with an exemplary embodiment of the present invention, and

FIG. 3 illustrates a schematic view of a user profile configuration interface in accordance with an exemplary embodiment of the present invention.

### DETAILED DESCRIPTION OF THE PRESENT INVENTION

Various exemplary embodiments are described with reference to the drawings, wherein like reference numerals are used to refer to like elements throughout. In the following description, for purpose of explanation, numerous specific details are set forth in order to provide a thorough understanding of one or more embodiments. It may be evident that such embodiments may be practised without these specific details.

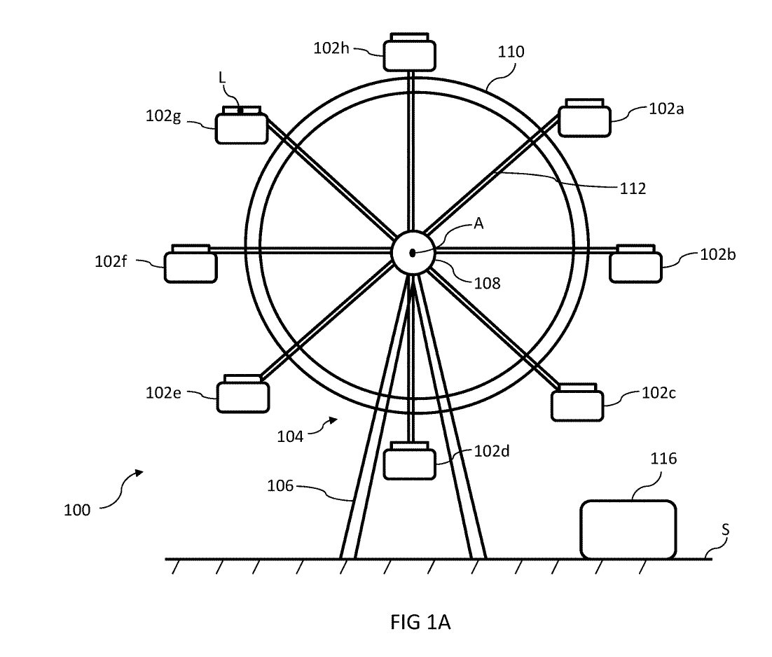

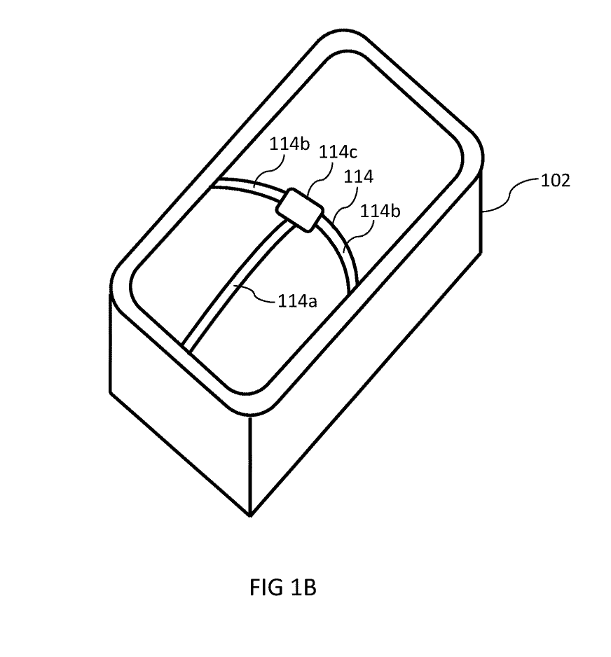

Referring now to FIGS. 1A and 1B, a schematic view of a multi-cradle system 100 and an individual cradle 102 thereof are respectively illustrated in accordance with various exemplary embodiments of the present invention.

The multi-cradle system 100 includes multiple cradles 102, a supporting frame 104, a base structure 106, a rotatable hub 108, a mounting wheel 110, multiple coupling beams 112, a restraining assembly 114, and a controller 116.

As can be seen in the adjoining figures, cradles 102a through 102g are mounted on the supporting frame 104. The cradles 102a through 102g are hereinafter collectively referred to as the cradles 102 and individually referred to as cradle 102.

It will be readily appreciated that the techniques of the present invention are not limited to any specific number of cradles included in the multi-cradle system 100. In various exemplary implementations of the present invention, any suitable number of cradles may be mounted on the supporting frame 104, as may be required.

In various exemplary embodiments of the present invention, the cradles 102 are mounted on the supporting frame 104 such as to permit movement of the cradles 102 relative to the supporting frame 104, as will be further understood from the following description.

The supporting frame 104 includes a base structure 106 which in turn supports the rotatable hub 108 and the mounting wheel 110. The rotatable hub 108 is configured for rotation about the axis of rotation (R). The mounting wheel 110 is operatively coupled to the rotatable hub 108 through the coupling beams 112. The cradles 102 are mounted on the mounting wheel 110.

In one exemplary embodiment, each cradle 102 is connected to the mounting wheel 110 using bracket means provided at opposite ends of the cradle 102 along a longitudinal axis (L) such that the cradle 102 are pivotally suspended from the mounting wheel 110 such as to permit reciprocating movement of each cradle 102 about the longitudinal axis (L) thereof.

In various exemplary embodiments of the present invention, driving means for causing reciprocating movement of the cradles 102 are provided. In one example, an electrical motor is used. The cradles 102 are also provided with cushioning springs. The cushioning springs are disposed between side walls of an individual cradle 102 and any suitable part of the mounting wheel 110 such as to ensure soft reciprocating movement of the cradles 102.

Various techniques to produce the desired reciprocating or ‘rocking’ movements in the cradles 102 are, in general, known in the art and hence, not being described in detail for sake of brevity.

As will now be clearly understood, the cradles 102 are mounted about the axis of rotation (R) of the rotatable hub 108 and are operatively coupled thereto through the mounting wheel 110 and the coupling beams 112. The rotatable hub 108 is, in turn, operatively coupled to driving means causing the rotatable hub 108 to rotate about the axis of rotation (R). Thus, rotation of the rotatable hub 108 results in rotation of the cradles 102 about the axis of rotation (R).

In one exemplary embodiment, as depicted in the adjoining figures, the axis of rotation (R) is substantially aligned with the mounting surface (S) whereupon the supporting frame 104 is placed. Such construction of the multi-cradle system 100 is similar to a conventional Ferris wheel arrangement.

In an alternative exemplary embodiment, the axis of rotation (R) is substantially orthogonal to the mounting surface (S) whereupon the supporting frame 104 is placed. As will be readily apparent, such construction of the multi-cradle system 100 is similar to a conventional merry-go-round arrangement.

In various exemplary embodiments of the present invention, the supporting frame 104 may be supported on the mounting surface (S) through base wheels attached to the base structure 106. The base wheels improve portability of the multi-cradle system 100 such that the multi-cradle system 100 may easily be moved from one available location on the mounting surface (S) to another.

Referring now specifically to FIG. 1B, an individual cradle 102 is illustrated. The cradle 102 includes the restraining assembly 114 for restraining an infant placed therein.

In various exemplary embodiments of the present invention, the restraining assembly 114 may be implemented using any suitable techniques available in the art. In the exemplary embodiment depicted in the adjoining figure, the restraining assembly 114 is implemented using a base strap 112a providing a locking mechanism 112c at its free end. The side straps 112b are coupled to the base strap 112a through the locking mechanism 112c such that the infant is restrained from falling out of the cradle 102.

It should be noted that the term “infant”, as used herein, is not, in any manner whatsoever, intended to be interpreted in a narrow sense to refer to a child belonging to a specific age group. The term “infant” has been used herein to generally refer to any such child who requires adult caretaking with respect to handling at least some basic needs. Thus, the term “infant” may be interpreted to include within its meaning such terms as new-born, neonate, baby, toddler, child and the like.

In general, an infant that is desired to be managed using the multi-cradle system 100 of the present invention should preferably be such that when in the recumbent position, it may generally fit into the cradle 102. Thus, the subject infant to be placed within the cradle 102 is limited only by length of the cradle 102 and not by any specific age limits. The length of cradle 102 may be suitably selected to address any desired age group.

As will be clear from the preceding description, the multi-cradle system 100 of the present invention is adapted to simultaneously carry multiple infants. Any desired number of infants up to the number of cradles 102 included in the multi-cradle system 100 may be managed using the multi-cradle system 100.

The multi-cradle system 100 of the present invention further includes the controller 116. The controller 116 may be embodied in a programmable logic controller and may further include a human-machine interface. The controller 116 may be operatively coupled to other parts of the multi-cradle system 100 through wired and/or wireless means.

The controller 116 implements therein a cradle management system, as will now be explained along with further technical features, structural details, and additional elements included in the multi-cradle system 100.

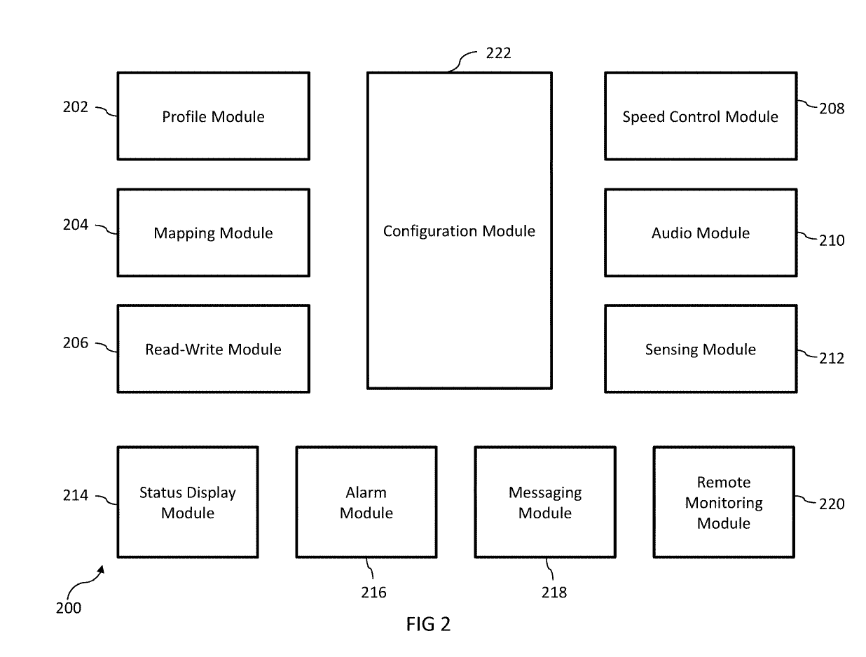

Referring now to FIG. 2, the cradle management system 200 includes various modules to manage various operational parameters of the multi-cradle system 100.

The cradle management system 200 includes a profile module 202, a mapping module 204, a read-write module 206, a speed control module 208, an audio module 210, a sensing module 212, a status display module 214, an alarm module 216, a messaging module 218, a remote monitoring module 220, and a configuration module 222.

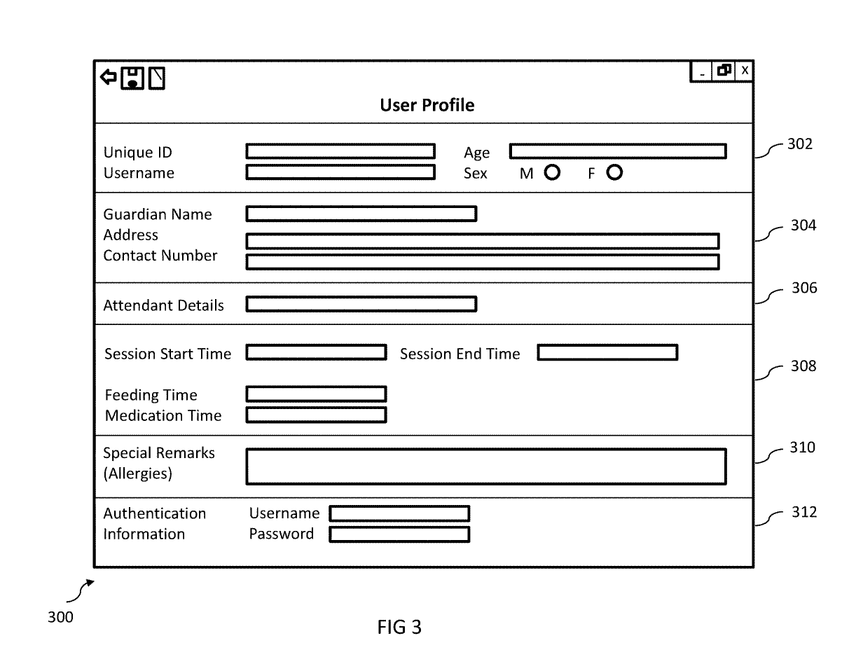

The cradle management system 200 includes a profile module 202, a mapping module 204, and a read-write module 206 for management of a user profile. In accordance with various exemplary embodiments of the present invention, a unique user profile is created for each infant that is desired to be managed using the multi-cradle system 100, as will be explained in detail later in conjunction with FIG. 3.

The cradle management system 200 further includes a speed control module 208 for regulating various driving means provided in the multi-cradle system 100. The audio module 210 is configured for playing back a pre-recorded audio file with the intended effect of soothing one or more infants placed in the multi-cradle system 100.

The sensing module 212 is configured for sensing an operating state of the restraining assembly 114 and generating a corresponding status message.

The status display module 214, the alarm module 216, the messaging module 218, and the remote monitoring module 220 are all configured to communicate information to an attendant located in proximity of the multi-cradle system 100 and/or a parent/guardian at a remote location.

The configuration module 222 is configured for receiving one or more user inputs for configuring one or more operational parameters associated with any of the functional modules included in the multi-cradle system 100, as described above.

A user profile configuration interface will now be explained in detail prior to providing further technical details about various functional modules included in the multi-cradle system 100 and specifically, the cradle management system 200.

Referring now to FIG. 3, a schematic view of a user profile configuration interface 300 is depicted in accordance with an exemplary embodiment of the present invention.

The user profile configuration interface 300 includes an infant details section 302, a guardian details section 304, an attendant details section 306, a time details sections 308, a special remarks section 310, and an authentication information section 312.

Each user profile is assigned a unique profile identity number. In an exemplary embodiment, this unique profile identity number is a system generated number.

The infant details section 302 permits inputting basic information related to an infant such as name, age, gender, and so on.

The guardian details section 304 permits inputting basic information related to a parent/guardian of the infant such as name, home address, mobile number, landline number and so on.

The attendant details section 306 permits inputting basic information related to an attendant appointed for caretaking of the infant.

The time details sections 308 includes various time related details including session start time, session end time, feeding time, medication time, and so on.

The special remarks section 310 permits inputting information related to any such information for which a specific section is not designed in the interface. The special remarks section 310 may be used to provide specific details of the medication to be given and in what manner and the like.

The authentication information section 312 is designed to permit configuration of authentication information such as a username and password. Such authentication information may be used by a parent/guardian to access the remote monitoring module 220 and thereby, remotely view an audio-video feed in respect of their child.

In various exemplary embodiments of the present invention, the user profile configuration interface 300 is rendered through a display panel included in the configuration module 222. An attendant is able to input the desired information using the user profile configuration interface 300. When a new profile is created, a unique profile identity number is automatically generated and assigned to the user profile.

Referring back to FIG. 2, the profile module 202 is configured for storing all user profiles. In various exemplary embodiments of the present invention, the configuration module 222 also assigns a unique identifier to each cradle 102 included in the multi-cradle system 100.

The mapping module 204 is configured for dynamically linking the unique profile identity number of the infant to the unique identifier of the cradle, when the infant is placed therein.

The operation of the multi-cradle system 100 will now be described in detail to explain further technical features of the present invention.

As mentioned earlier, the configuration module 222 provides various user interfaces to configure various operational parameters such as unique identifier of individual cradles 102, individual user profiles, operating speeds of the driving means for actuating reciprocating movement in the individual cradles 102, operating speeds of the driving means for actuating rotational movement in the rotatable hub 108, play-back of audio files through the audio module 210, and so on. The configuration module 222 is also used for setting various alerts and alarms, and setting up communication interfaces for enabling status display module 214, alarm module 216, messaging module 218, and remote monitoring module 220.

The configuration module 222 may be implemented using a suitable human machine interface. In an exemplary embodiment, the configuration module 222 may be accessed through a user interface on a hand-held device such that an attendant or a parent/guardian is able to remotely manage the multi-cradle system 100.

When initially a new infant is to be managed using a given multi-cradle system 100, an attendant uses the configuration module 222 to access user profile configuration interface 300. Using the user profile configuration interface 300, the attendant configures a new user profile for the infant. The user profile is stored in the profile module 202.

Optionally, the user profile thus created may also be stored in one or more external memory devices. Such external memory device may be a wrist band to be worn by the infant. In addition, the external memory device may be any suitable portable device that provides a storage memory such as a USB drive, an RFID card, and so on. The external memory device may also be embodied in a handheld computational device for example a mobile phone, personal digital assistant, and so on.

The attendant uses the read-write module 206 to write the user profile in the external memory device. It will be readily appreciated that any suitable data communication modality may be used to implement the read-write module 206. For example, if the desired external memory device is an RFID card, the read-write module 206 includes RFID writing and reading capabilities.

In fact, in various exemplary embodiments of the present invention, the read-write module 206 may provide support for multiple such read-write modalities to support any desired wired and/or wireless communication protocols such as RFID, Bluetooth, Near-Field Communication (NFC), USB, and so on.

In one exemplary embodiment, in addition to a main read-write module, the read-write module 206 includes individual reader modules installed in individual cradles 102.

The user profile is stored in both a wrist band to be worn by the infant and also, a suitable external memory device such as a smart phone carried by the parent/guardian.

Thus, when the infant is placed in a particular cradle 102, the unique profile identity number of the corresponding user profile is detected through the reader and provided to the mapping module 204. The unique identifier of individual cradle 102 may be expressly provided or may be determined based on the reader module sending the unique profile identity number information. The mapping module 204 accordingly dynamically links the unique profile identity number to the unique identifier of individual cradle 102.

In an alternative exemplary embodiment of the present invention, the attendant may dynamically link the unique identifier of individual cradle 102 and the unique profile identity number using a suitable user interface rendered through the configuration module 222.

The parent/guardian subsequently may leave the premises where the multi-cradle system 100 is installed such as a nursery or day care facility.

The parent/guardian may access the user profile on the external memory device embodied in the portable device carried by them. As noted earlier, the user profile includes the authentication information.

It will now be appreciated that when the same infant is to be managed at a later time, the parent/guardian may provide the external memory device and the user profile may directly be retrieved using the reader module in the read-write module 206, thereby, avoiding the need to set-up a new user profile every time a given infant is to be managed using the multi-cradle system 100 of the present invention.

The attendant may regulate the speed of the driving means regulating reciprocating movement of the individual cradles 102 and/or the rotatable hub 108 through the speed control module 208.

In addition, the attendant may configure play-back of a pre-recorded audio file. The attendant is able to store any number of pre-recorded audio files in the multi-cradle system 100. In one example, the attendant may also store pre-recorded audio files provided by the parent/guardian of an infant.

In one embodiment of the present invention, a central audio output device may be included in the audio module 210 such that the play-back is audible to all infants placed in the individual cradles 102. In an alternative embodiment, individual audio output devices are installed in the individual cradles 102 such that different audio files may be played-back for infants in the individual cradles 102.

When the attendant places an infant in the cradle 102, the restraining assembly 114 should be activated to ensure safety of the infant. The sensing module 212 is configured to sense an operating state of the locking mechanism 112c, that is activated or deactivated. If the locking mechanism 112c is not activated, the sensing module 212 sends a corresponding status message to the status display module 214, which displays the status message through a suitable display device. The sensing module 212 further sends the status message to the alarm module 216, which in turn generates suitable audio and visual alarms to get attendant's attention.

The status display module 214, in various exemplary embodiments of the present invention, is configured for displaying one or more parameters associated with such user profiles that are linked with the unique identifier. Thus, the status display module 214 may display upcoming feed/medication timings in accordance with individual user profiles such that the attendant is able to attend to required caretaking tasks in a desired manner.

In an exemplary embodiment of the present invention, the cradle management system 200 is implemented such as to enable both directed communication between individual modules as well as bus-based communication such that individual modules may intercept relevant messages broadcast over a communication bus and perform preconfigured actions in accordance with information included in the broadcast message.

Thus, the alarm module 216, for example, is configured for generating an alarm message based on a status message provided thereto. Such status message may be generated by the sensing module 212 as well as any other suitable module in the multi-cradle system 100.

The messaging module 218 is configured for transmitting a notification message corresponding to at least one of the cradle 102 to a remote device based on the user profile of an infant placed therein. The messaging module 218 retrieves messaging related information such as notification preferences from the user profile. If the parent/guardian has indicated a preference to be notified regarding status of various caretaking activities related to the infant, the messaging module 218 sends desired notification messages to the parent/guardian in accordance with contact details such as mobile number and/or email address included in the user profile.

One exemplary use case related to performing a feeding activity is explained below.

The present invention contemplates that when an individual infant feeding time is due after a defined time period, for example, 15 minutes, a corresponding status message is displayed through the status display module 214. The attendant is thus informed about the upcoming need for feeding the given infant. When the attendant performs the required task of feeding the given infant, the attendant indicates the completion of the feeding activity using the display interface provided in the status display module 214. The status display module 214 generates a corresponding activity completion message and broadcasts over a communication bus. The messaging module 218 intercepts such message and in turn, dispatches an appropriate message to the parent/guardian.

If, on the other hand, the attendant fails to timely address the feeding activity, the status display module 214 generates a status message indicating the failure to perform a required task. The alarm module 216 intercepts such status message and generates an appropriate audio-visual alarm. The messaging module 218 sends a notification message to the parent/guardian indicating the failure to perform the scheduled feeding activity.

The parent/guardian may also actively monitor the status of its infant through the remote monitoring module 220.

The remote monitoring module 220 is configured for capturing at least one of a video and an audio feed corresponding to each of the cradles 102 and permitting access to the video and/or audio feeds corresponding to an individual cradles 102 based on provision of authentication information in respect thereof.

In one exemplary embodiment of the present invention, each cradle 102 is provided with an audio and/or a video capturing device, such as a webcam. The parent/guardian is able to access the audio-video feed through the remote monitoring module 220. It is contemplated that the parent/guardian accesses the remote monitoring module 220 through an application installed on a hand-held device such as a smart phone or tablet, or a computational device such as a personal computer, laptop, and the like. The application is configured to connect to the remote monitoring module 220. The parent/guardian is prompted to provide authentication information such as a username and a password. The remote monitoring module 220 receives the provided authentication information and matches the authentication information stored in the profile module 202. Based on successful authentication, the remote monitoring module 220 permits access to the audio-video feed captured in the cradle 102 in which the infant corresponding to the user profile is placed. Thus, the parent/guardian is able to monitor its infant in real time.

Thus, the present invention advantageously facilitates management of multiple infants in an efficient manner. Owing to systematic handling of infant needs through respective user profiles, the present invention reduces reliance on adult supervision and helps in attending to various child care tasks in a convenient and timely manner.

The present invention further advantageously provides regular status messages to the parent/guardian. Further, the present invention advantageously enables a parent/guardian to actively monitoring the infant from a remote location as and when desired.

Evidently, the multi-cradle system of the present invention is beneficial for use in various kinds of child care facilities such as nurseries, hospitals, crèche at offices, and so on.

While the present invention has been described in detail with reference to certain embodiments, it should be appreciated that the present invention is not limited to those embodiments. In view of the present disclosure, many modifications and variations would present themselves, to those of skill in the art without departing from the scope of various exemplary embodiments of the present invention, as described herein. The scope of the present invention is, therefore, indicated by the following claims rather than by the foregoing description. All changes, modifications, and variations coming within the meaning and range of equivalency of the claims are to be considered within their scope.

1. A multi-cradle system adapted for managing a plurality of infants, said multi-cradle system comprising
a plurality of cradles mounted on a supporting frame, each cradle being assigned a unique identifier,
a profile module, said profile module configured for storing at least one user profile of an infant, and
a mapping module, said mapping module configured for dynamically linking said user profile to one of said cradles using said unique identifier thereof, when said infant is placed therein.

2. The multi-cradle system according to claim 1, wherein said cradles are mounted such as to permit movement thereof relative to said supporting frame, and further wherein, said multi-cradle system further comprises a speed control module for regulating movement of said cradles.

3. The multi-cradle system according to claim 1, wherein said cradles are pivotally mounted on said supporting frame such as to permit reciprocating movement along a longitudinal axis thereof.

4. The multi-cradle system according to claim 1, wherein said supporting frame comprises at least one rotatable hub, and further wherein said cradles are mounted about an axis of rotation of said rotatable hub and are operatively coupled thereto such that a rotation of the rotatable hub results in rotation of said cradles about said axis of rotation.

5. The multi-cradle system according to claim 4, wherein said axis of rotation is substantially aligned with a mounting surface whereupon said supporting frame is placed.

6. The multi-cradle system according to claim 4, wherein said axis of rotation is substantially orthogonal to a mounting surface whereupon said supporting frame is placed.

7. The multi-cradle system according to claim 1 further comprising a restraining assembly for restraining an infant therein, wherein said restraining assembly is individually installed in each of said cradles.

8. The multi-cradle system according to claim 7 further comprising a sensing module configured for sensing an operating state of said restraining assembly and generating a corresponding status message.

9. The multi-cradle system according to claim 1 further comprising an audio module configured for playing back at least one pre-recorded audio file.

10. The multi-cradle system according to claim 1 further comprising a status display module, said status display module configured for displaying one or more parameters associated with such user profiles that are linked with said unique identifier.

11. The multi-cradle system according to claim 1 further comprising an alarm module, said alarm module configured for generating an alarm message based on a status message provided thereto.

12. The multi-cradle system according to claim 1 further comprising a messaging module, said messaging module configured for transmitting a notification message corresponding to at least one of said cradles to a remote device based on said user profile of an infant placed therein.

13. The multi-cradle system according to claim 1 further comprising a remote monitoring module, said remote monitoring module configured for generating at least one of a video and an audio feed corresponding to each of said cradles and permitting access to said video and/or audio feeds corresponding to an individual cradles based on provision of authentication information in respect thereof.

14. The multi-cradle system according to claim 1 further comprising a configuration module, said configuration module configured for receiving one or more user inputs for configuring one or more operational parameters associated with said multi-cradle system.

15. The multi-cradle system according to claim 1 further comprising a read-write module configured for communicatively coupling to an external memory device, wherein said external memory device stores at least one user profile, and wherein said read-write module is configured for retrieving said user profile from said external memory device.
